(19) United States
(12) Patent Application Publication
(10) Pub. No.: US 2008/0002785 A1
(43) Pub. Date: Jan. 3, 2008

(54) TRANSMITTER HAVING A PASSIVE PRE-EMPHASIS UNIT

(76) Inventors: Ga Won Kim, Daejeon (KR); Joung Ho Kim, Daejeon (KR)

Correspondence Address: DALY, CROWLEY, MOFFORD & DURKEE, LLP, SUITE 301A, 354A TURNPIKE STREET, CANTON, MA, 02021-2714, US

(21) Appl. No.: 11/679,392

(22) Filed: Feb. 27, 2007

(30) Foreign Application Priority Data
Jun. 28, 2006 (KR) 2006-58754

(51) Int. Cl. H04L 25/49

(52) U.S. Cl. 375/296

(57) ABSTRACT

A passive pre-emphasis unit includes a plurality of transmission lines that is arranged in parallel with one another and has uniform intervals therebetween, and each of the plurality of transmission lines is alternately connected to the same ends. The passive pre-emphasis unit pre-emphasizes an input signal.

### CROSS-REFERENCE TO RELATED APPLICATIONS

This application claims priority under 35 USC § 119(a) to Korean Patent Application No. 2006-0058754, filed on Jun. 28, 2006 in the Korean Intellectual Property Office, the contents of which are herein incorporated by reference in their entireties.

### BACKGROUND OF THE INVENTION

1. Field of the Invention

The present invention relates to a transmitter, and more particularly to a transmitter having a passive pre-emphasis circuit that pre-emphasizes a high frequency component of a signal.

2. Description of the Related Art

When a digital signal is transmitted through a lossy channel at a transmitter end, the digital signal is received as a distorted signal at a receiver end according to a frequency characteristic of channels. Generally, the lossy channel has greater loss at a high frequency because the high frequency component of the signal transmitted through the lossy channel is more attenuated than a low frequency component of the signal transmitted through the lossy channel. The frequency component of the signal corresponds to a rising edge or a falling edge of the signal where a voltage level of the signal changes quickly. Thus, the signal through the lossy channel has a distorted waveform compared with an original waveform, and has a different arrival time of the transmitted signal according to a frequency. Consequently, the signal through the lossy channel overall has a lot of jitters and a reduced timing margin. In another aspect, there is an inter-symbol interference (ISI) in the lossy channel. Because of loss in the channel, the arrival time of the signal may be different according to frequency component, and successive data may be overlapped, thereby being improperly delivered in shot channel or in high-speed data communication.

A pre-emphasis scheme is introduced for solving the above-described problems. The pre-emphasis scheme pre-emphasizes a high frequency component of the signal before transmitting the pre-emphasized signal. However, the conventional pre-emphasis circuits are implemented with active elements such as a filter and an amplifier.

### SUMMARY OF THE INVENTION

Accordingly, the present invention is provided to substantially obviate one or more problems due to limitations and disadvantages of the related art.

Example embodiments of the present invention may provide a transmitter with a passive high frequency pre-emphasis unit.

Example embodiments of the present invention may also provide a signal transmitting method by using a passive high frequency pre-emphasis unit to generate a pre-emphasized signal.

In some example embodiments of the present invention, a passive pre-emphasis unit includes a plurality of transmission lines that are arranged in parallel with one another and have uniform intervals from one another. Each of the plurality of transmission lines is alternately connected to the same ends. The passive pre-emphasis unit pre-emphasizes an input signal.

In some embodiments, the plurality of the transmission lines may be connected in the configuration of meander delay lines.

In some embodiments, the plurality of the transmission lines may be connected in the configuration of flat spiral delay lines.

In some embodiments, the passive pre-emphasis unit may further include an output driver that amplifies the pre-emphasized signal to be outputted to channels. In some embodiments of the present invention, a signal transmitting method includes generating a signal to be transmitted and applying the signal to a pre-emphasis unit that includes a plurality of transmission lines configured to be arranged in parallel with one another and have uniform intervals from one another. Here, each of the plurality of transmission lines is alternately connected to the same ends.

In some embodiments, the plurality of the transmission lines may be connected in the configuration of meander delay lines.

In some embodiments, the plurality of the transmission lines may be connected in the configuration of flat spiral delay lines.

Accordingly, the transmitter including the pre-emphasis unit is capable of pre-emphasizing the output signal by using the passive pre-emphasis unit, and has a reduced power consumption and electromagnetic interference (EMI).

### BRIEF DESCRIPTION OF THE DRAWINGS

The present invention will become more apparent to those of ordinary skill in the art by describing, in detail, example embodiments thereof with reference to the attached drawings, wherein like elements are represented by like reference numerals, which are given by way of illustration only and thus do not limit the example embodiments of the present invention.

FIG. 1 is a block diagram illustrating a transmitter including a pre-emphasis circuit according to an example embodiment of the present invention;

FIG. 2 is a diagram illustrating a crosstalk that occurs between adjacent transmission lines;

FIG. 3 is a schematic diagram illustrating a meander delay line adopted in the pre-emphasis unit of FIG. 1;

FIG. 4 is an eye diagram illustrating a waveform of the output signal from the meander delay line in FIG. 3;

FIG. 5 is a schematic diagram illustrating a flat spiral delay line adopted in the pre-emphasis unit of FIG. 1; and

FIG. 6 is an eye diagram illustrating a simulation result of the pre-emphasis signal by using the meander delay line of FIG. 4.

### DESCRIPTION OF THE EMBODIMENTS

Embodiments of the present invention now will be described more fully with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout this application.

It will be understood that, although the terms first, second, etc. may be used herein to describe various elements, these elements should not be limited by these terms. These terms are used to distinguish one element from another. For example, a first element could be termed a second element, and, similarly, a second element could be termed a first element, without departing from the scope of the present invention. As used herein, the term “and/or” includes any and all combinations of one or more of the associated listed items.

The terminology used herein is for the purpose of describing particular embodiments and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

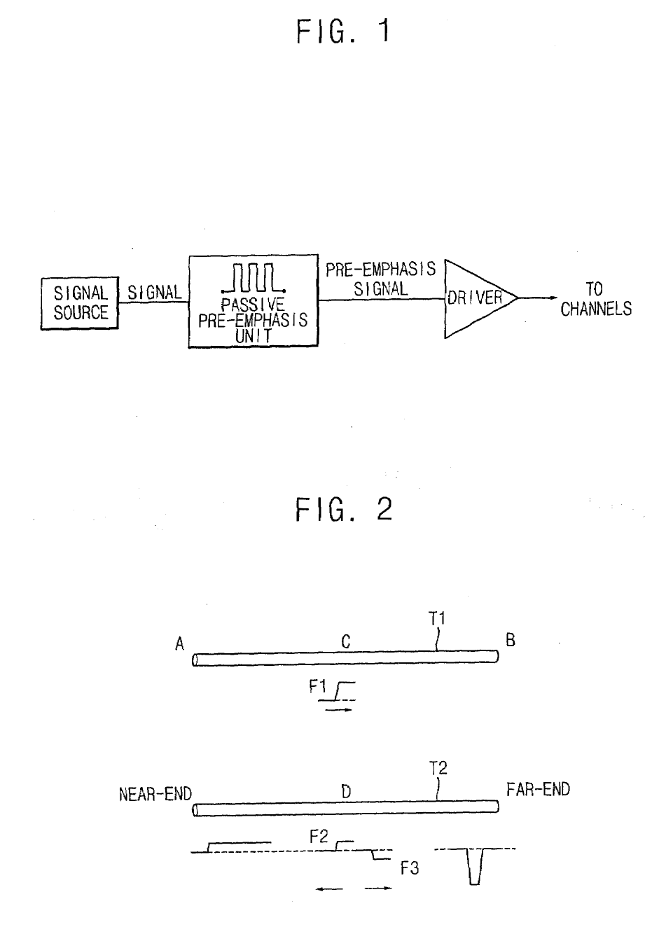

FIG. 1 is a block diagram illustrating a transmitter including a pre-emphasis circuit according to an example embodiment of the present invention.

Referring to FIG. 1, a transmitter 10 includes a signal source 11, a passive pre-emphasis unit 12 and an output driver 13. The signal source 11 generates a data signal. The data signal is converted to a pre-emphasis signal through the pre-emphasis unit 12 and has a waveform shaped. The pre-emphasis signal is amplified for driving channels by the output driver 13. The passive pre-emphasis unit 12 includes a plurality of transmission lines that is crowded and connected to turn. The data signal goes through the plurality of transmission lines to be outputted as pre-emphasis signal. Detailed descriptions on how the pre-emphasis signal is generated in the passive pre-emphasis unit 12 will be explained hereinafter.

FIG. 2 is a diagram illustrating a crosstalk that occurs between adjacent transmission lines.

Referring to FIG. 2, a first transmission line T1 and a second transmission line T2 are adjacently arranged for being electrically coupled. A high frequency signal F1 is applied to the first transmission line T1 along the directions A and B. While the high frequency signal F1 propagates through the first transmission line T1, voltage signals F2 and F3 having similar waveforms with the high frequency signal F1 are induced in the second transmission line T2. The induced voltage signals F2 and F3 are determined according to voltage of the high frequency signal F1, a mutual inductance between the first transmission line T1 and the second transmission line T2, a self inductance of the second transmission line T2 and a self capacitance of the second transmission line T2. As soon as the induced voltage signals F2 and F3 are generated, the induced voltage signals F2 and F3 having reverse polarities, respectively propagate to opposite directions along the second transmission line T2. For example, when the high frequency signal F1 passes through a point C of the first transmission line T1, the induced voltage F2 having the same polarity as the high frequency signal F1 propagates to a near end at a point D of the second transmission line T2, whereas the induced voltage F3 having the reverse polarity as the high frequency signal F1 propagates to a far end at the point D of the second transmission line T2. Because propagation speeds of the high frequency signal F1, induced voltage signals F2 and F3 are substantially the same, the induced voltage signal F2 continuously arrives at the near end of the second transmission line T2, and the induced voltage signal F3 overlappedly arrives at the far end of the second transmission line T2. Thus, a waveform having a regular level is found at the near end, and a waveform having a high level is temporarily found at the far end when the high frequency signal F1 arrives at the point B. In addition, a crosstalk represents a delivery of information of the signal along one transmission line to another transmission line.

When the B point of the first transmission line T1 and the far end of the second transmission line T2 are connected with each other, the high frequency signal F1 in the first transmission line T1 propagates from the far end to the near end of the second transmission line T2. In this case, there exist already the induced voltage signals F2 and F3 in the second transmission line T2, a signal having a mixed waveform of the induced voltage signal F2 and the high frequency signal F1 at the near end is found.

When the number of the transmission lines is not less than three and the transmission lines are connected to turn, a signal from the last transmission line has accumulated crosstalks, and thus a leading edge of the signal from the last transmission line is distorted. The transmission lines may be connected so as that the output signal may have a waveform of the pre-emphasis signal, and the waveform of the output pre-emphasis signal may be determined in accordance with a length, a time delay, a width, a number of the transmission lines and intervals therebetween.

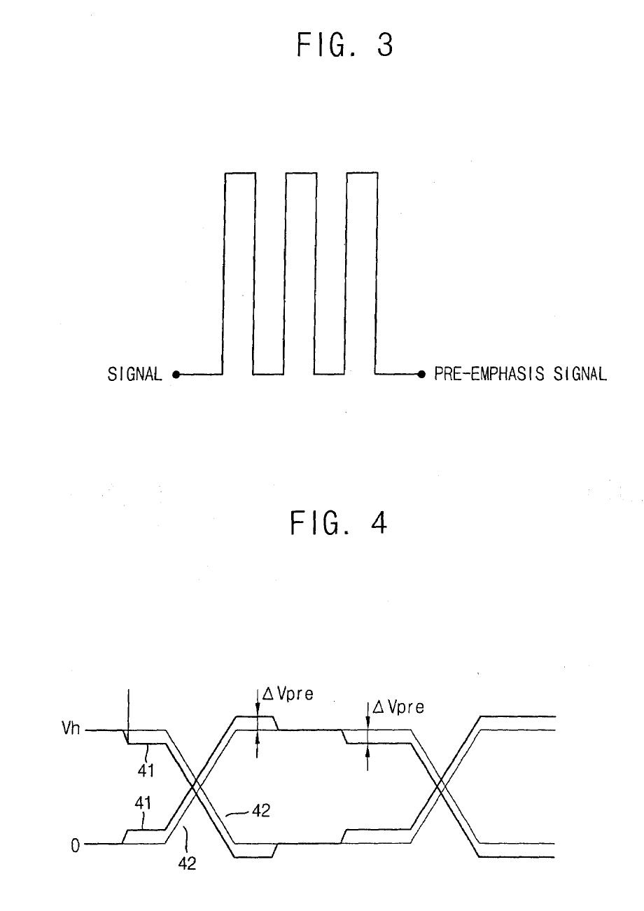

FIG. 3 is a schematic diagram illustrating a meander delay line adopted in the pre-emphasis unit of FIG. 1.

Referring to FIG. 3, a meander delay line has a configuration of a plurality of transmission lines that is arranged in parallel with one anther and has uniform intervals therebetween, and each of the plurality of transmission lines is alternately connected to the same ends. A signal is applied to an input end of a first transmission line, and is outputted at an output end. A starting point of the first transmission is referred to as a near end, and the opposite point of the near end is referred to as a far end. The unit length of the transmission line may be set in order that a unit time delay, a time required for the propagation of the signal along the unit length of the transmission line, is relatively short compared with a period of the signal. In addition, the width of the transmission line may be determined for a characteristic impedance of the transmission line, because the characteristic impedance of the transmission line is generally set to 50Ω.

FIG. 4 is an eye diagram illustrating a waveform of the output signal from the meander delay line in FIG. 3.

Referring to FIG. 4, a bolded line 41 represents a waveform of the output signal from the meander delay line, a general line 42 represents a waveform of an ideal output signal, i.e., a signal without pre-emphasis.

The signal is pre-emphasized at the near end, and the amount of the pre-emphasis (ΔVpre) may be approximated by following [Equation 1]. The signal level is raised by the amount of pre-emphasis in case of a rising edge, and the signal level is lowered by the amount of pre-emphasis in case of a falling edge.

$$Δ Vpre \approx ( N - 1 ) \times kNEXT \times Vh , \qquad [ Equation 1 ]$$

wherein N denotes the number of the transmission lines, kNEXT denotes a near-end crosstalk coefficient, and Vh denotes a magnitude of the signal.

In addition, kNEXT is a coefficient that is determined in accordance with the physical configuration of the meander delay line, a mutual inductance, a mutual capacitance between the last transmission line from which the pre-emphasis signal is outputted and other transmission lines, a self inductance, and a self capacitance of the last transmission line. In FIG. 4, kNEXT is expressed by the following [Equation 2].

kNEXT=¼(Cm/C11+Lm/L11), [Equation 2]

wherein Cm and Lm denote a mutual capacitance and a mutual capacitance, respectively, and Cl1 and Cl2 denote a self capacitance and a self inductance, respectively.

Cm, Lm, Cl1 and Cl2 are entirely determined according to the physical configuration of the meander delay line such as the number, length, width and interval of the transmission lines. The desired near-end crosstalk coefficient generated by properly setting the number, length, width and interval of the transmission lines, and the desired pre-emphasis unit for generating the desired pre-emphasis signal may be designed by setting the number, length, width and interval of the transmission lines properly.

The pre-emphasis unit may adopt another configuration of delay line in which a crosstalk is generated according to an example embodiment of the present invention.

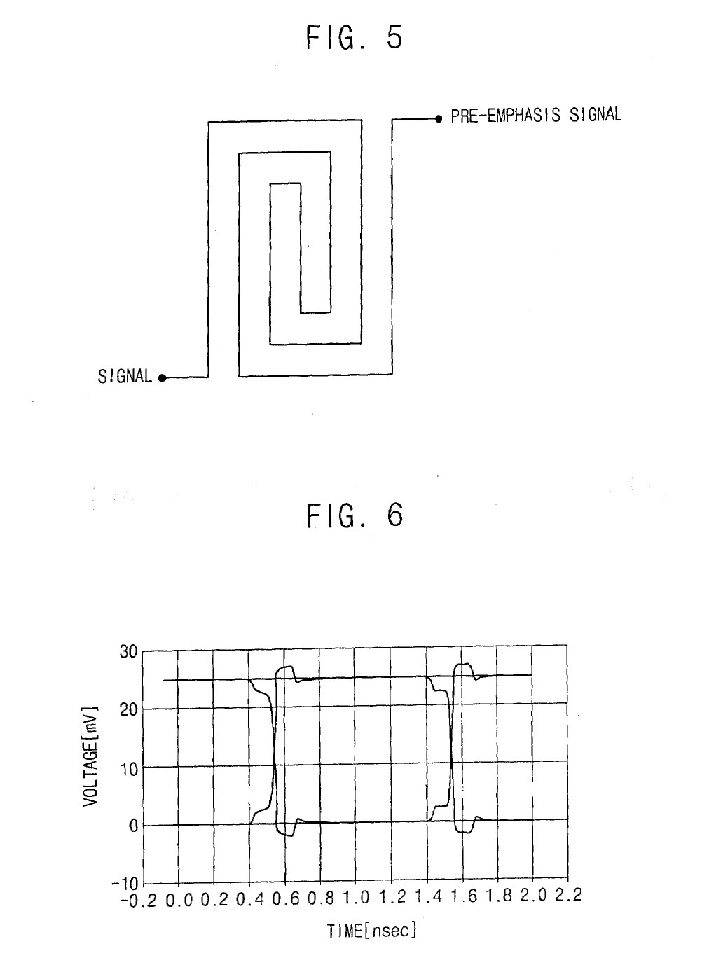

FIG. 5 is a schematic diagram illustrating a flat spiral delay line adopted in the pre-emphasis unit of FIG. 1.

Referring to FIG. 5, a flat spiral delay line has a relatively uniform crosstalk compared with the meander delay line, and has a reduced output loss resulted from the crosstalk. The principle of the flat spiral delay line of FIG. 5 is basically the same as the principle of the meander delay line of FIG. 4. Therefore, detailed description of the flat spiral delay line will be omitted.

According to some embodiments, the delay lines may correspond to a differential meander delay line and a differential flat spiral delay line. These differential delay lines have the same principle as the general delay lines except that the differential delay lines may pre-emphasize a differential signal, and thus any further detailed descriptions will be omitted herein.

FIG. 6 is an eye diagram illustrating a simulation result of the pre-emphasis signal by using the meander delay line of FIG. 4.

In FIG. 6, the number of the transmission lines corresponds to 4, and the length corresponds to 10 mm, the width corresponds to 0.18 mm, and the interval therebetween corresponds to 0.18 mm. The signal has a frequency of 2 Gbps, and is pseudo random bit. The output signal illustrates pre-emphasis characteristics that the output signal is strengthened at the rising edge or the falling edge thereof.

Accordingly, the transmitter including the pre-emphasis unit according to an example embodiment of the present invention is capable of pre-emphasizing the output signal by using the passive pre-emphasis unit, and has a reduced power consumption and an EMI compared with an active pre-emphasis unit. In addition, the desired pre-emphasis characteristic may be obtained by adjusting the physical configuration of the delay lines, and thus the transmitter may be easily designed.

Having thus described example embodiments of the present invention, it is to be understood that the invention defined by the appended claims is not to be limited by particular details set forth in the above description as many apparent variations thereof are possible without departing from the spirit or scope thereof as hereinafter claimed.

What is claimed is:

1. A transmitter comprising;
a passive pre-emphasis unit configured to pre-emphasize an input signal and including a plurality of transmission lines that are configured to be arranged in parallel with one another and have uniform intervals therebetween, each of the plurality of transmission lines being alternately connected to the same ends.

2. The transmitter of claim 1, wherein the plurality of the transmission lines is connected in the configuration of meander delay lines.

3. The transmitter of claim 1, wherein the plurality of the transmission lines is connected in the configuration of flat spiral delay lines.

4. The transmitter of claim 1, further comprising an output driver that amplifies the pre-emphasized signal to be outputted to channels.

5. A signal transmitting method comprising:
generating a signal to be transmitted; and
applying the signal to a pre-emphasis unit including a plurality of transmission lines configured to be arranged in parallel with one another and having uniform intervals therebetween, each of the plurality of transmission lines being alternately connected to the same ends.

6. The signal transmitting method of claim 5, wherein the plurality of the transmission lines is connected in the configuration of meander delay lines.

7. The signal transmitting method of claim 5, wherein the plurality of the transmission lines is connected in the configuration of flat spiral delay lines.
